(19) United States
(12) Patent Application Publication
(10) Pub. No.: US 2007/0215806 A1
(43) Pub. Date: Sep. 20, 2007

(54) Active infrared barrier with two-way cells that can both transmit and receive IR signals

(75) Inventor: Bruno Bomparet, Lyon (FR)

Correspondence Address: HOFFMANN & BARON, LLP, 6900 JERICHO TURNPIKE, SYOSSET, NY, 11791, US

(73) Assignee: SORHEA

(21) Appl. No.: 11/716,117

(22) Filed: Mar. 9, 2007

(30) Foreign Application Priority Data
Mar. 16, 2006 (FR) FR0602310

(51) Int. Cl. G01J 5/00

(52) U.S. Cl. 250/338.1

(57) ABSTRACT

The present invention relates to an active infrared barrier consisting of at least two exactly identical columns arranged opposite each other. The active infrared barrier possesses two-way infrared cells that fulfill both the transmission and receiving functions, allowing time-division multiplexing by optical synchronization. Thus, each cell can emit and receive an infrared beam.

### CROSS-REFERENCE TO RELATED APPLICATION

This application claims priority to French Patent Application No. FR0602310, filed on Mar. 16, 2006, which is incorporated herein by reference.

### BACKGROUND OF THE INVENTION

1. Field of the Invention

The present invention concerns the technical field of active infrared barriers having a range of 15-200 m for perimeter protection.

2. Description of the Related Art

Active infrared barriers are known which consist:

of a transmitter box that generates invisible infrared beams (the beams are generated by a pulsed infrared light source which is made to be directional with an angle of about plus or minus 2° due to the optics of the transmission cell); and

a receiver box which receives these rays, analyzes them, and detects the passage of an intruder between the two boxes.

The receiving cell, which is located in the field of the emission cone, picks up the infrared pulses and transforms them into an electrical signal. It is the absence of a signal, after analysis by the receiving column, which triggers the alarm. The active infrared barriers thus function as a positive security device.

In the case of complex perimeters with several barriers in series, this architecture requires the use of different infrared columns with different configurations:

single transmitting direction column;

single receiving direction column;

double transmitting direction column;

double receiving direction column; and

mixed way transmitting+receiving column (in these columns, two types of cells are used: receiving cells and transmitting cells. The transmitting cells of a column are arranged opposite the receiving cells of the other column, and vice versa).

This involves a multiplication of a number of the product item numbers to be managed and stored. In addition, any control error entails a risk of lengthening delays in implementing the project.

In addition, the different columns have to be placed correctly as a function of the result that one wishes to achieve, where an error in arrangement results in dysfunction of the entire device of the barrier type.

Another difficulty of the devices of the prior art is to achieve an optimal alignment between the different barriers. For this purpose, active infrared barriers require that the transmitters and receivers be aligned perfectly; in other words, a perfect coincidence of the optical axes of the two cells, the transmitting cell and the receiving cell, must be achieved. This alignment difficulty naturally increases as a function of the distance between the two cells. The alignment difficulty with a long-range infrared barrier does not consist in achieving the correct alignment of the receiving boxes, but primarily in obtaining the correct alignment of the transmitter boxes of each barrier, because no signal value is available locally.

Systems for the return of optical- or wire-transmitted information have been developed to allow correct alignment of the transmitters, but they remain dependent on correct transmission of the information coded in the infrared signal, or they require additional cabling (example: optical alignment feedback on Optex 650 MKIII™, wire-based alignment feedback on Sorhea Maxiris 2000™).

Another disadvantage resides in the cabling itself. Indeed, current infrared barriers deliver their warning information at the level of the receiving side of the barrier. Their cabling therefore requires, notably as far as warning information is concerned, either a detailed planning of the placement and orientation of each barrier, or numerous civil engineering undertakings to connect together the receiving columns of each barrier.

### SUMMARY OF THE INVENTION

In view of all the above-mentioned disadvantages, it is necessary to develop an active infrared barrier which can be set up easily, even in the case of complex perimeters to be protected, while ensuring an optical alignment of the cells.

The present invention concerns an active infrared barrier that consists of at least two exactly identical columns arranged opposite each other and covering a distance of at most 100 m for constant operation.

The principal innovation resides in the utilization of new two-way infrared cells (including both the transmitting and the receiving functions) which allow realizing time-division multiplexing by optical synchronization.

### BRIEF DESCRIPTION OF THE DRAWINGS

FIG. 1 describes a double sweep.

FIG. 2 describes a phase of synchronization of the two columns A and B.

FIG. 3 shows the columns A and B during operation, in mutual dialogue.

FIG. 4 shows an integrated alignment aid tool.

### DETAILED DESCRIPTION OF THE PREFERRED EMBODIMENTS

The invention thus concerns an active infrared barrier which has exactly identical columns, with two-way infrared cells covering both emission and reception functions, and realizing time-division multiplexing by optical synchronization. Thus, each cell can emit transmit and receive an infrared beam.

Thus a double interlaced sweep with infrared beams is generated between each pair of cells (pair of two columns).

The major difficulty has consisted in synchronizing the transmission/reception cycles of the two cells comprising the barrier. The cells switch alternately from the emission to the reception mode. When a cell transmits an infrared beam, the second cell must necessarily be in the receiving mode. The synchronization is done optically when the barrier is switched on.

This optical synchronization comprises four channels (frequencies), which can be selected to differentiate among the barriers (suppression of interfering infrared beams from the other barriers).

The time-division multiplexing consists in transmitting the infrared beams of a given column one after the other. The optical synchronization consists in generating an infrared code which makes it possible to associate unequivocally the transmission and reception cells of the same barrier.

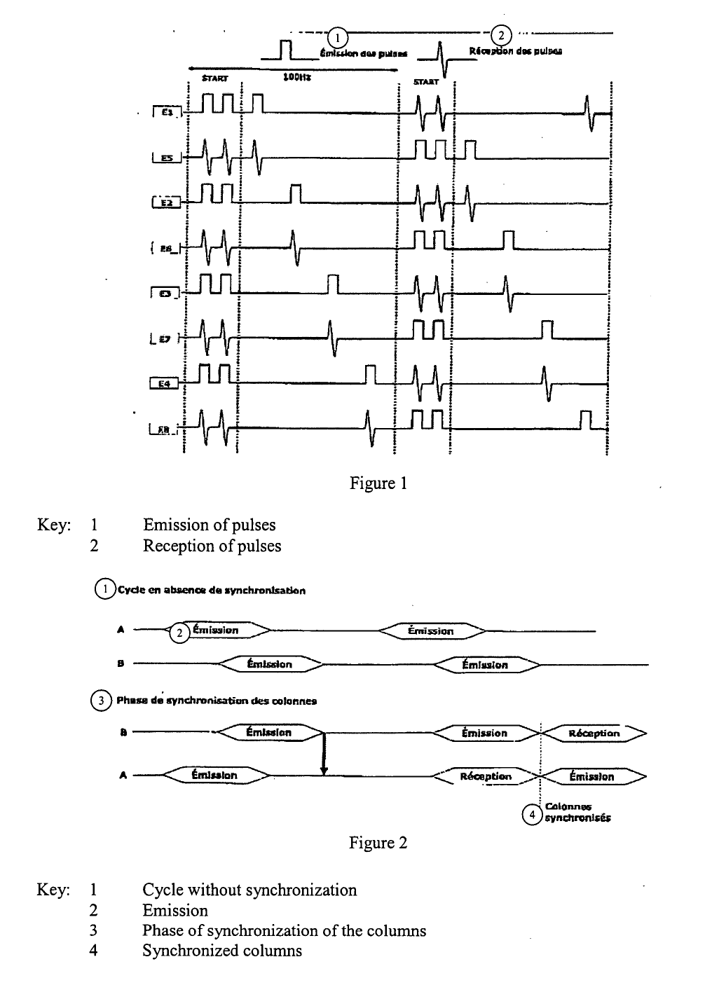

The utilization of two-way cells makes it possible to generate a double interlaced sweep (two time-division multiplexing operations) at a frequency of 100 Hz. FIG. 1 below describes this double sweep.

The time-division multiplexing with optical synchronization is carried out as follows:

During the first sweep (by analogy to video, one can say during the first field) corresponding to the beams 1, 2, 3, 4, the cells of column A are transmitting, and those of column B are receiving.

During the second field, corresponding to the beams 5, 6, 7, 8, the functions of the cells are reversed; column A becomes receiver and column B becomes transmitter.

FIG. 2 describes the phase of synchronization of the two columns A and B.

A “start” (starting signal) present at each beginning of a field allows the achievement of the optical synchronization.

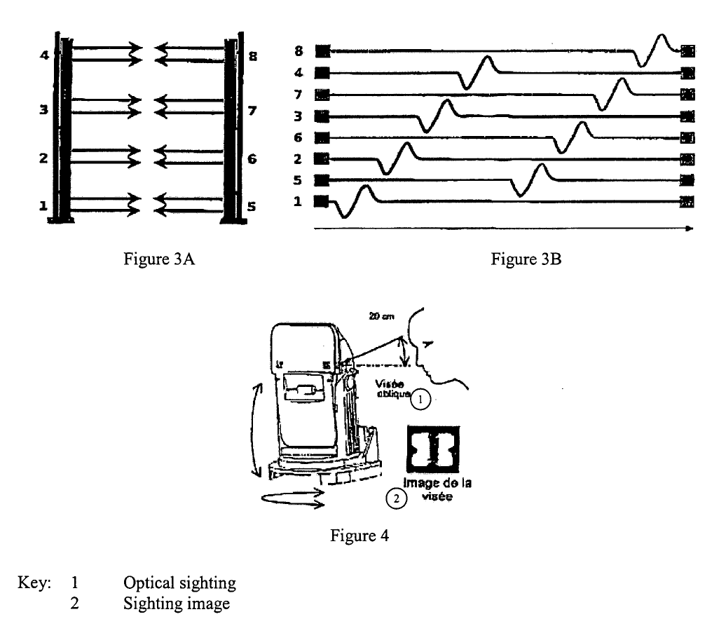

FIG. 3 shows the columns A and B during operation, in mutual dialogue.

Each infrared beam is multiplexed and synchronized optically at a frequency of 100 Hz.

Thanks to this system, all the columns are identical, which results in time being saved during the installation (since no attention is required to the types of columns that are placed), and greatly limits the risks of reference errors.

Since the cells according to the present invention comprise the double transmission/reception function, one can align each barrier simply by using the receiving function of the cells.

In addition, tools that help achieve alignment and are integrated in the column allow an optimal alignment to be produced for the optical axes of all the cells comprising the barrier.

Said integrated alignment aid tools, which are represented in FIG. 4, comprise:

An integrated optical telescopic sight on each cell:

This telescope makes it possible to produce an optical pre-alignment of the cells. The sighting consists in visualizing the image of the opposite column on a mirror integrated in the cell. The alignment is made in vertical and horizontal planes by direct orientation of the cell.

A powerful “buzzer” (audible signal transmitting system), whose sound level varies as a function of the power of the signal received; and

An LED (light-emitting diode) indicator which allows the visualization of the received signal level.

These instruments thus make it possible for a single person to align the beams with extreme precision without having to use any external apparatus, which simplifies the installation of the active infrared barrier.

The columns are preferably 1.10-1.90 m high, but they can naturally have the height required for the desired application.

Said columns notably consist of 2, 3, or 4 cells per direction, one management card per direction, and an optional 230 VAC/12 VDC power supply per column.

Said columns can in addition consist of any type of sensor/detector, or other independent elements placed in or on the column, provided these elements use the output contacts of the column according to the present invention. For example, said columns can be associated with video surveillance devices for visually monitoring the perimeter to be protected.

The applications of the active infrared barrier according to the present invention notably concern industrial sites, SME/SMI, institutions, long-term car parking garages, warehouses, individual houses, and more generally, all places requiring protection of their perimeter.

The invention also covers all the embodiments and all the applications that will be directly accessible to the person skilled in the art after reading the present application, and from his/her own knowledge.

1. An active infrared barrier comprising at least two exactly identical columns, said columns comprising two-way infrared cells, the cells being capable of both transmitting and receiving an infrared ray, the cells making it possible to achieve time-division multiplexing by optical synchronization.

2. The barrier according to claim 1, comprising an interlaced double sweep of infrared beams is generated between each pair of cells (pair of two columns).

3. The barrier according to claim 1, wherein the synchronization of the emission/reception cycles is achieved by the cells, which pass alternately into the emission mode and then into the receiving mode, when a cell transmits an infrared beam, the second must be necessarily in the receiving mode.

4. The barrier according to claim 3, wherein the synchronization is produced optically when the barrier is switched on.

5. The barrier according to claim 3, wherein said optical synchronization comprises four channels (frequencies) which can be selected to differentiate among the barriers (suppression of interfering infrared beams of the other barriers).

6. The barrier according to claim 1, wherein the time-division multiplexing comprises transmitting the infrared beams of a given column one after the other, and the optical synchronization comprises generating an infrared code which allows creating an unequivocal association between the transmission and reception cells of a given barrier.

7. The barrier according to claim 1, wherein the utilization of two-way cells allows the creation of double interlaced sweep (two time-division multiplexing operations) at a frequency of 100 Hz, each infrared beam being multiplexed and synchronized optically at a frequency of 100 Hz.

8. The barrier according to claim 1, wherein the time-division multiplexing with synchronization is carried out as follows:
during the first sweep (in analogy to video, one can say during the first field) corresponding to the beams 1, 2, 3, 4, the cells of column A are transmitting, and those of column B are receiving;
during the second field, corresponding to the beams 5, 6, 7, 8, the functions of the cells are reversed, column A becomes receiver and column B becomes transmitter; and
a “start” present at the beginning of each field allowing the achievement of the optical synchronization.

9. The barrier according to claim 1, wherein said barrier comprises alignment aid tools which are integrated in the column and allow an optimal alignment of the optical axis of all the cells comprising the barrier.

10. The barrier according to claim 9, wherein said integrated alignment aid tools comprise:
an integrated optical telescopic sight on each cell,
the telescope making it possible to produce an optical pre-alignment of the cells, the sighting comprising visualizing the image of the opposite column on a mirror integrated in the cell, the alignment being made in vertical and horizontal planes by direct orientation of the cell;
a powerful “buzzer”, whose sound level varies as a function of the power of the signal received; and
an LED indicator which allows visualization of the received signal level.

11. The barrier according to claim 1, wherein the columns preferably have a height of 1.10-1.90 m, but naturally can also have the height required for the desired application, and they comprise 2, 3 or 4 cells per direction, one management card per direction, and one optional 230 VAC/12 VDC power supply per column.

12. The barrier according to claim 11, wherein said columns can moreover consist of any type of sensor/detector, or other independent elements, placed in or on the column, provided these elements use the output contacts of the column according to the present invention. For example, said columns can be associated with video surveillance devices to visually monitor the perimeter to be protected.

13. The barrier according to claim 1, adapted for use in at least one of industrial sites, SME/SMI, institutions, long-term car parking garages, warehouses, individual houses, and, any place that requires protection of their perimeters.
